(19) United States
(12) Patent Application Publication
(10) Pub. No.: US 2024/0085641 A1
(43) Pub. Date: Mar. 14, 2024

(54) LOOP BACK PLUG WITH RETRACTABLE ALIGNMENT PINS

(71) Applicant: Westek Electronics, Inc., Watsonville, CA (US)

(72) Inventor: Kevin B. LARKIN, Pebble Beach, CA (US)

(21) Appl. No.: 18/457,267

(22) Filed: Aug. 28, 2023

Related U.S. Application Data
(60) Provisional application No. 63/404,142, filed on Sep. 6, 2022.

(51) Int. Cl. G02B 6/38

(52) U.S. Cl. CPC G02B 6/3882; G02B 6/3823; G02B 6/3885

(57) ABSTRACT

A connector having a housing and with the purpose of housing and protecting connectorized fiber cable and or cables while being mated to a component. The connector secures and holds in place the ends of the connectorized fiber. The connector has a cavity having an alignment guide pin therein and the guide pin can be moved back and forth to create the function of a male pin when in a first position and to create the function of a female cavity when in a second position.

### CROSS-REFERENCE TO RELATED APPLICATIONS

This application claims priority to and the benefit of U.S. Provisional Patent Application No. 63/404,142, filed on Sep. 6, 2022, entitled “LOOP BACK PLUG WITH RETRACTABLE ALIGNMENT PINS” by Kevin B. Larkin, and assigned to the assignee of the present Application, the disclosure of which is hereby incorporated herein by reference in its entirety.

### FIELD OF THE INVENTION

The present invention pertains to tools for looping back of electronic signals on fiber optic cables and equipment.

### BACKGROUND

The purpose of this invention is to eliminate the need for buying two different versions of this specific tool (one male version and one female version) which are both used for the purpose of looping back electronic signals on fiber optic cables and equipment.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of the Drawings should be understood as not being drawn to scale. Herein, like items are labeled with like item numbers.

FIGS. 1-28 are views of a loop back connector, in accordance with embodiments of the present invention.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included in the spirit and scope of the various embodiments. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail so as not to unnecessarily obscure aspects of the described embodiments.

Reference throughout this specification to “one embodiment,” “certain embodiments,” “an embodiment,” “various embodiments,” “some embodiments,” or similar term(s) means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

Although one or more embodiments of the present invention have been described in some detail for clarity of understanding, it will be apparent that certain changes and modifications may be made within the scope of the various embodiments. Accordingly, the described embodiments are to be considered as illustrative and not restrictive, and the scope of the various embodiments is not to be limited to details given herein, but may be modified. In the various embodiments, elements and/or any described steps do not imply any particular order of operation, unless explicitly stated therein.

The invention creates both versions in one tool with the ability to convert gender with the slide of a switch. The test function of the equipment found in data centers and in other areas where fiber optic electronic signals are generated and received consists of specialized electronic for doing so.

The fiber transmission that we are discussing is in the form of packets of light and generated by lasers. The Light packet and or packets are generally transmitted in series or in two separate directions. One direction, leaving the equipment is known as transmitting and the other direction is known as receive.

The transmit and receive laser light packets are generated and received in the same manner as the older copper wire electrical transmissions which were also known as transmit and receive.

The means of testing the transmission side and the receive side of the equipment is generally done by means of looping the signal and or signals back into the equipment and or cables for the purpose of testing.

In today's environments, the lasers doing the transmitting and the equipment that is doing the receiving are packaged together in most cases. The equipment jacks that the fiber cables plug into are equipped with alignment guides that are generally found in the form of slots and or ridges and or pins. To facilitate these means of alignments one area will be of a male type creating a protrusion while the female side is usually a cavity (designed to receive a male pin).

The function of this invention can be utilized on conventional patch and transmission cords and also loop back plugs.

Also note that the fiber connector and the fiber jack can range from 8 single fiber conductor to 36 fibers conductors or more which is why the alignment pins and sockets are so critical.

Also note that in the application out lined above that the cable plug ins are generally female but not always and the equipment side receiving jacks are usually male but not always, Thus, being one of the many reasons for this invention which is referred to herein as connector 100.

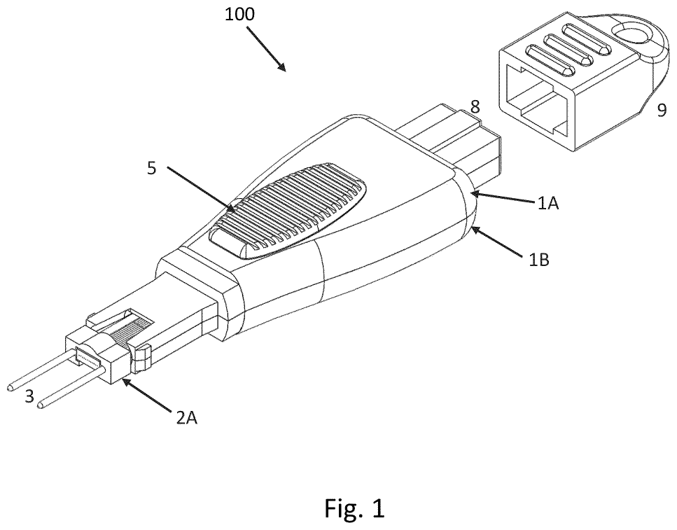

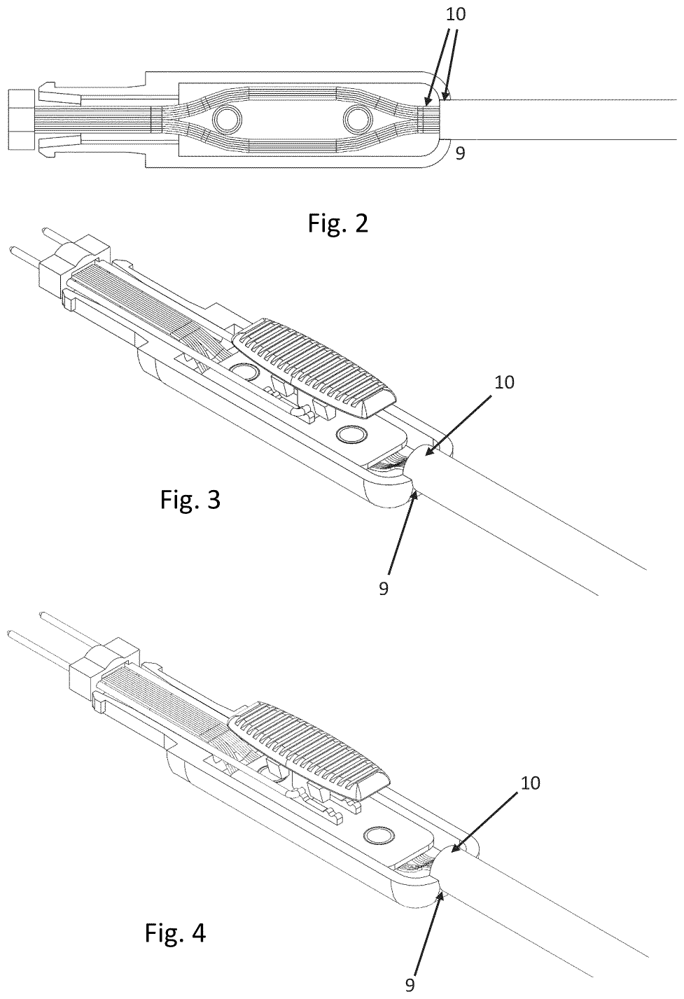

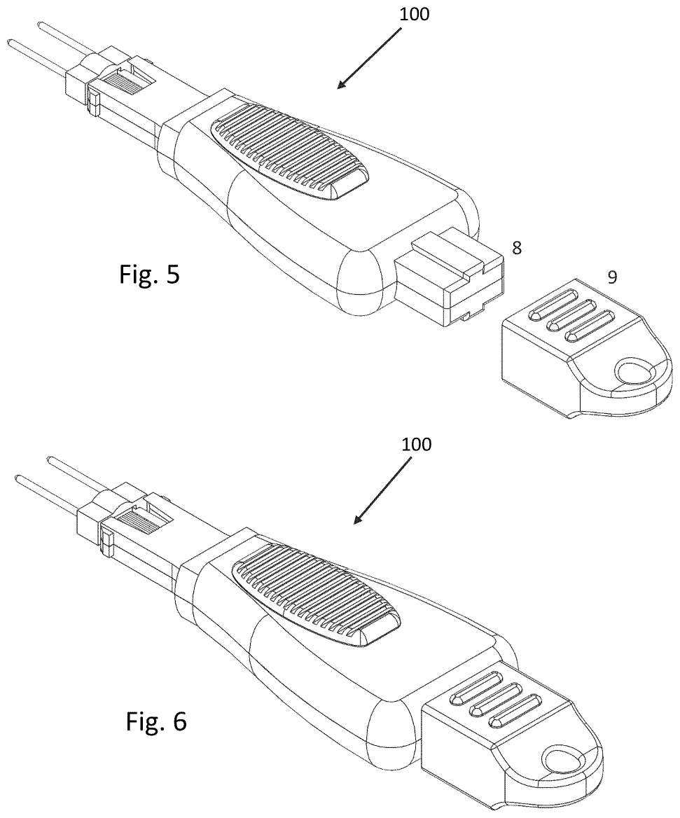

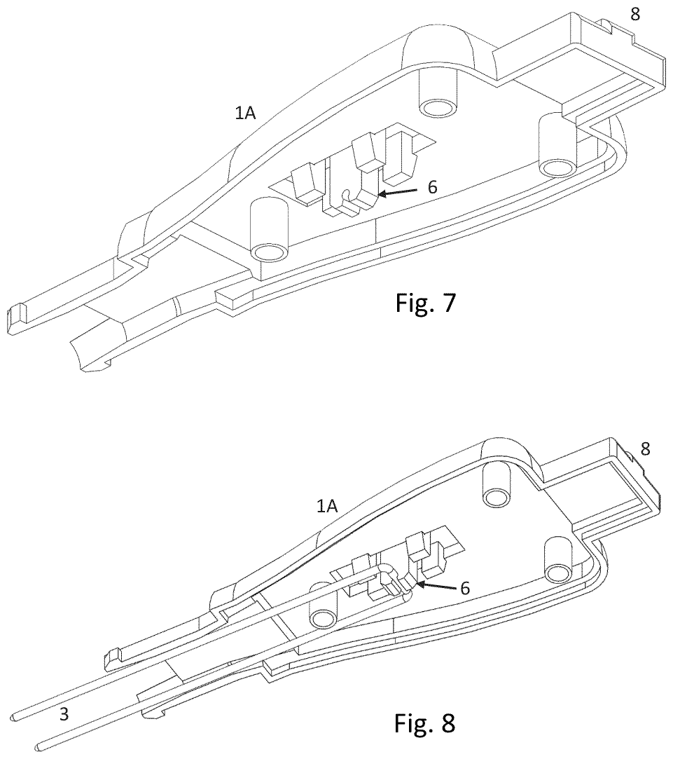

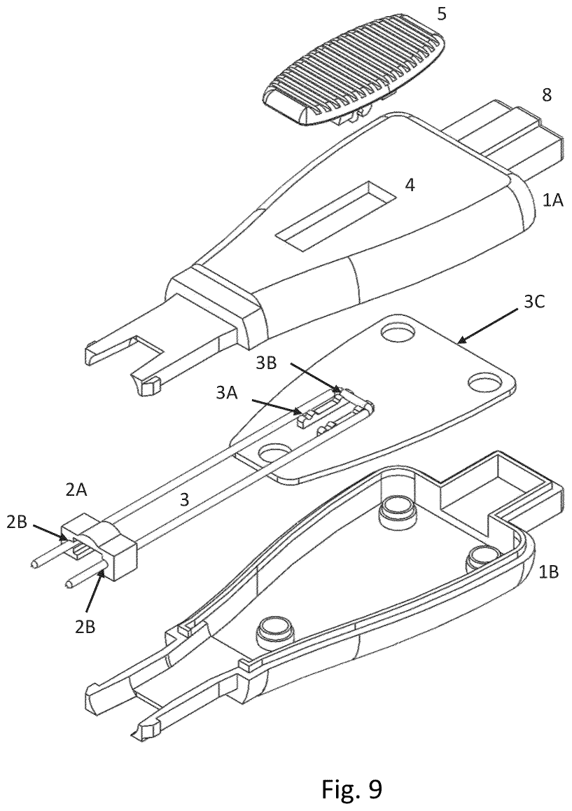

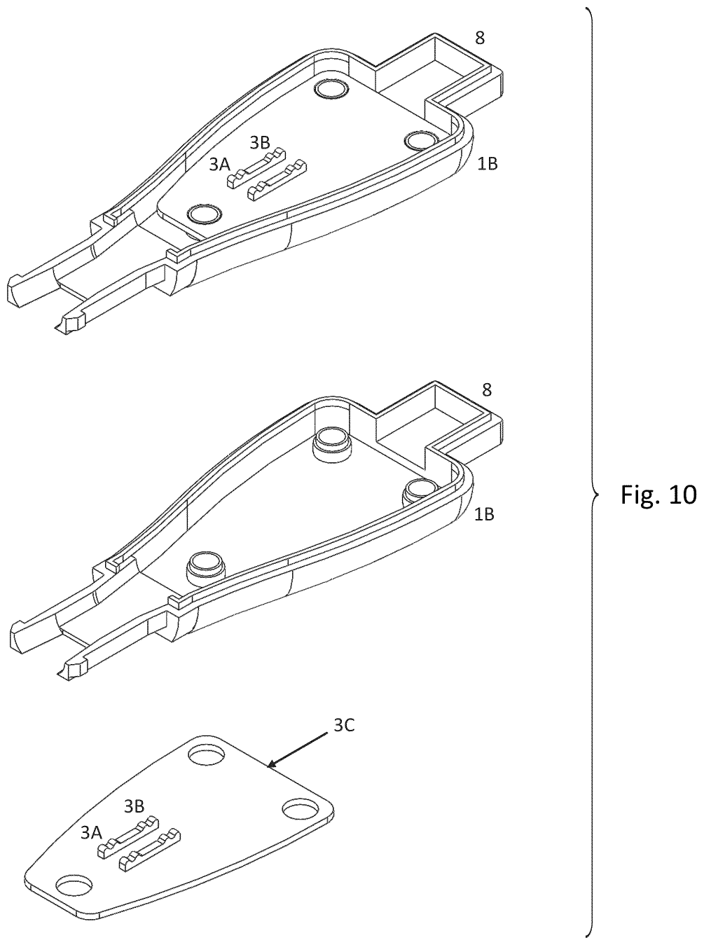

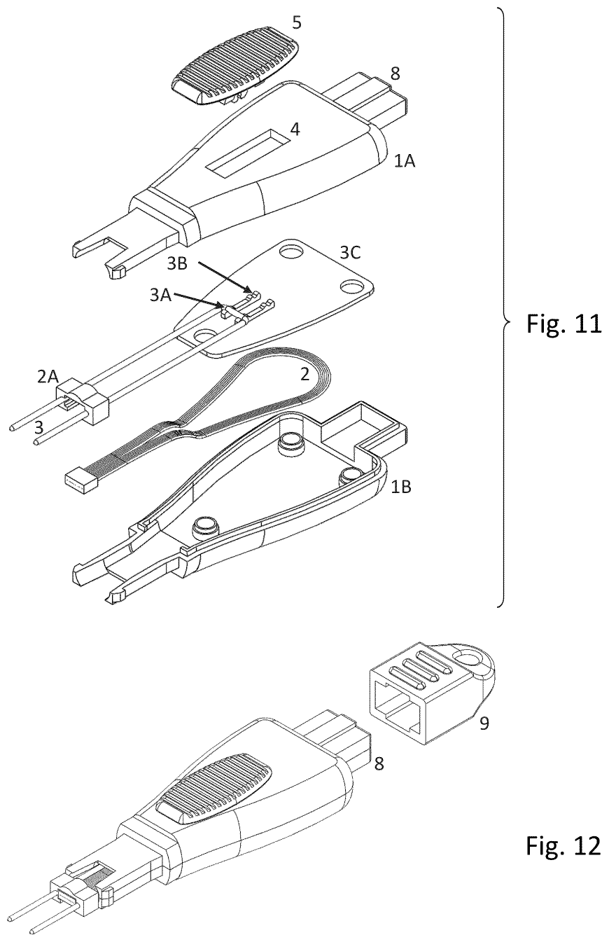

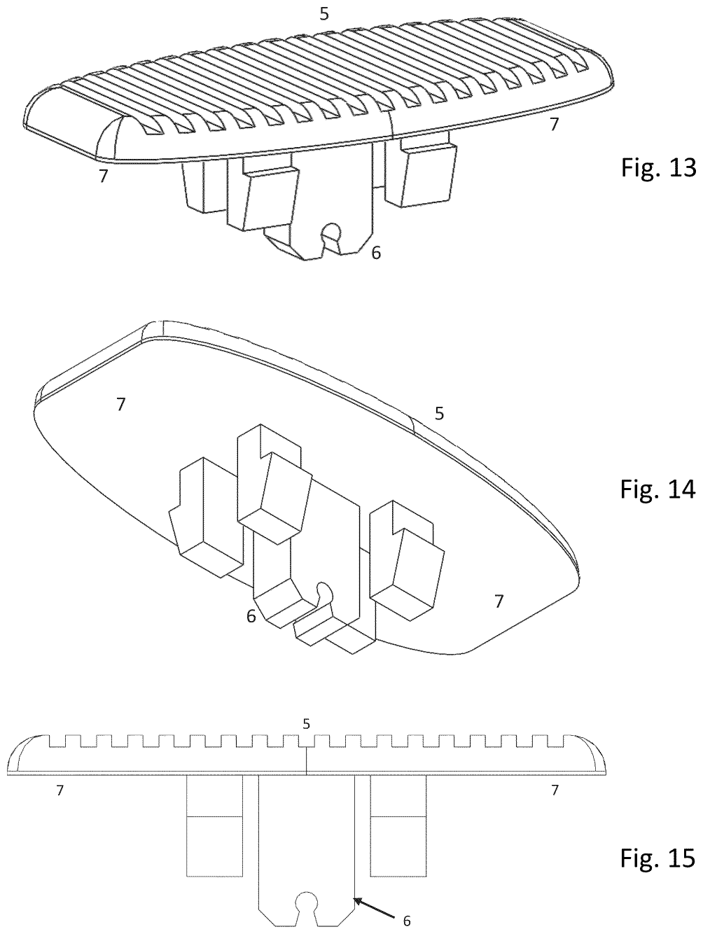

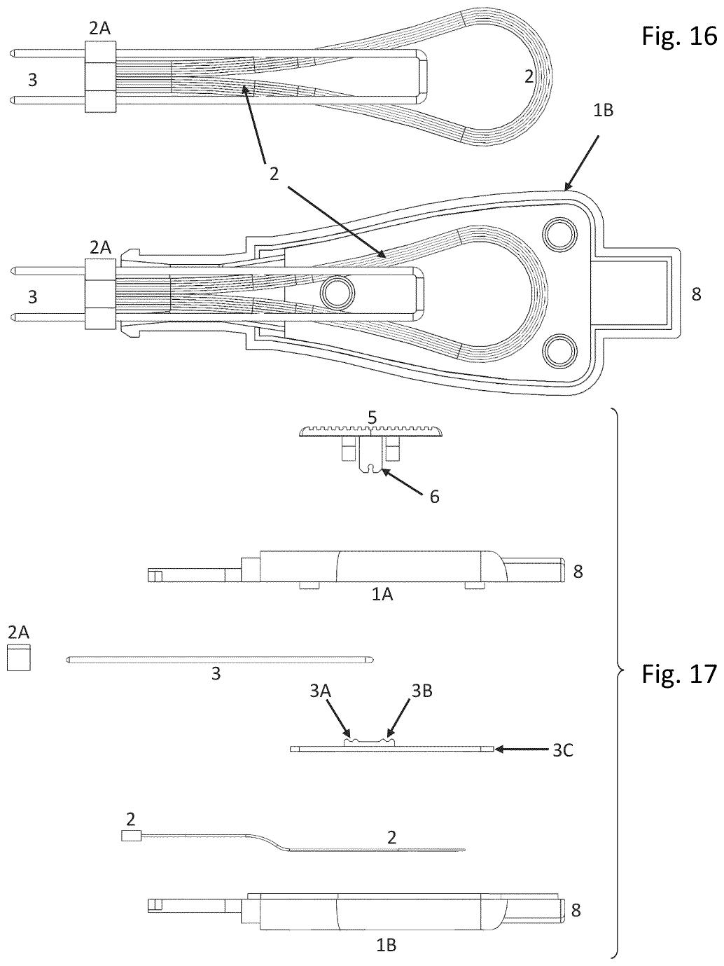

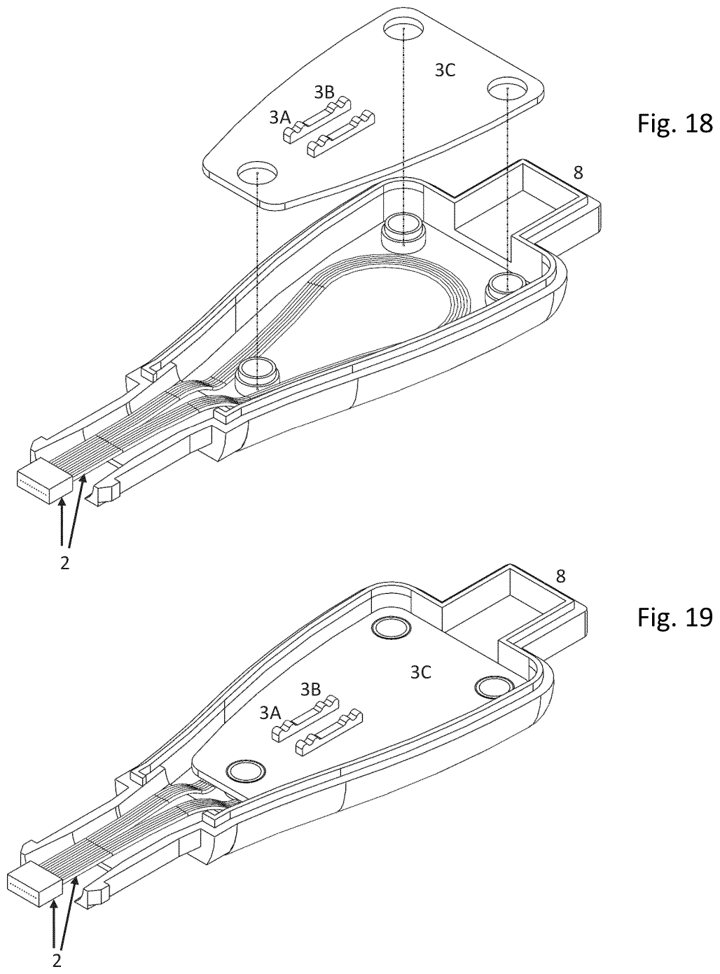

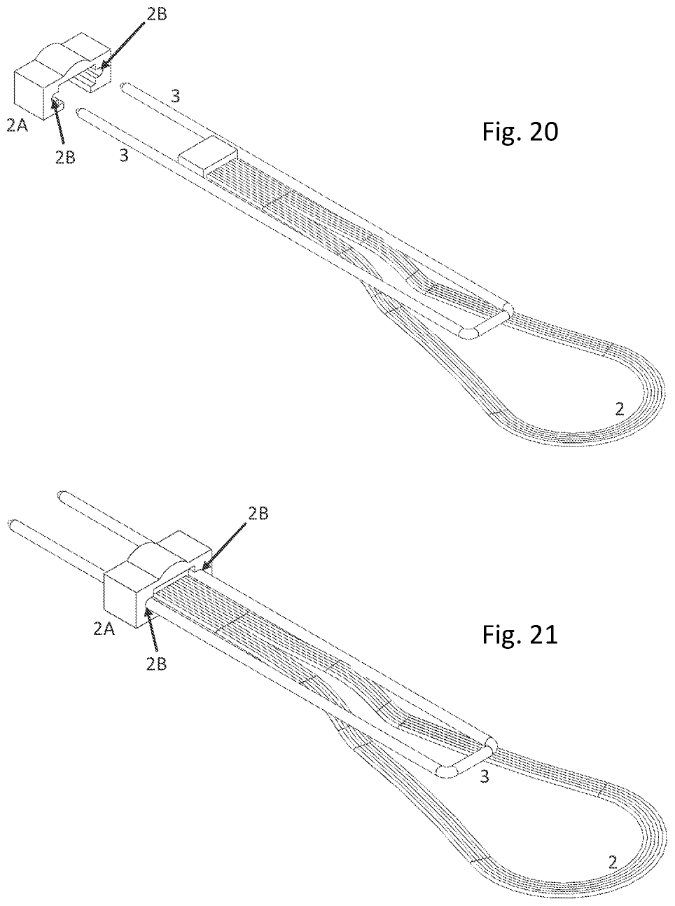

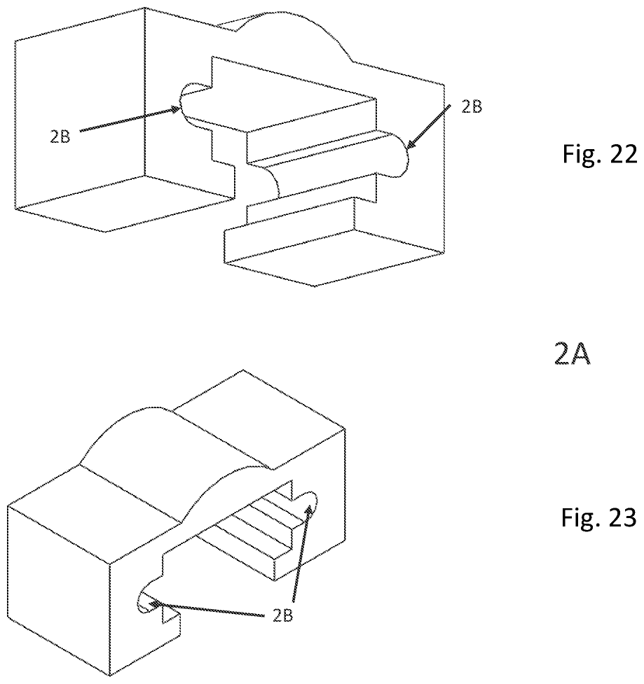

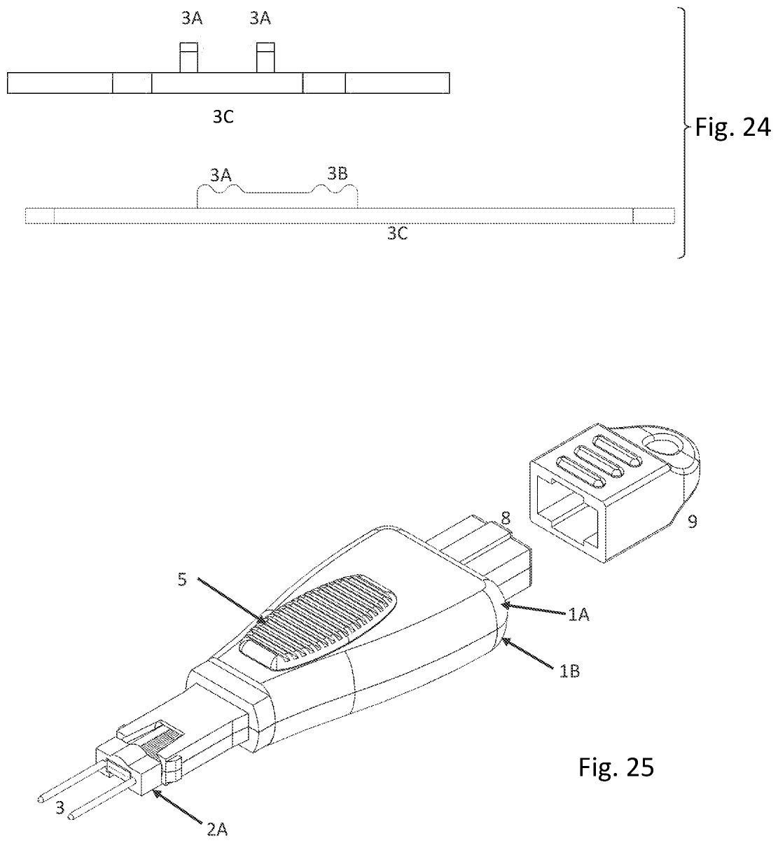

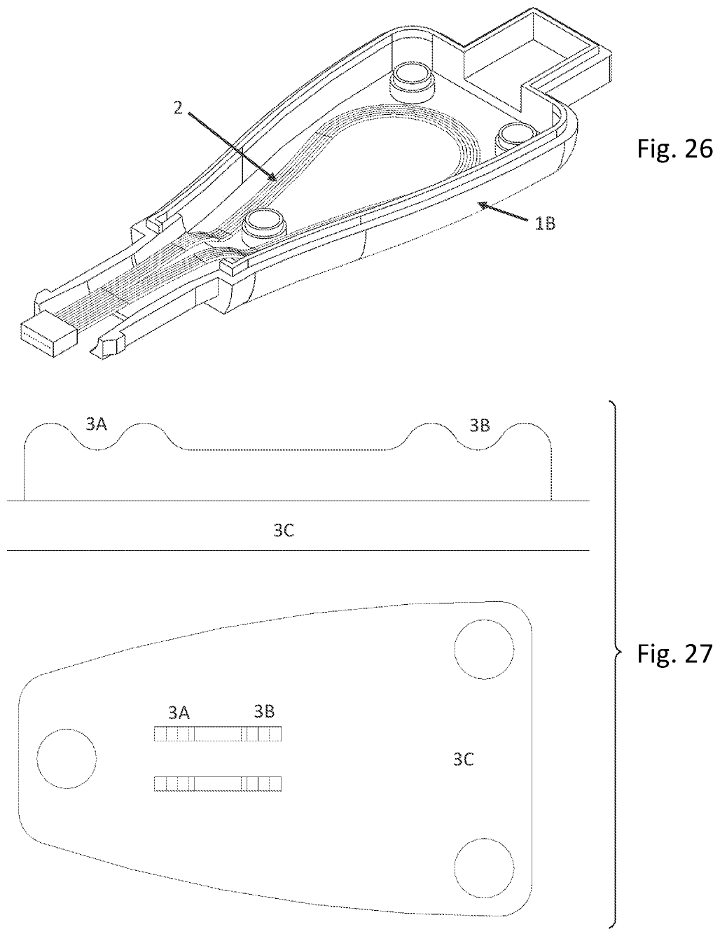

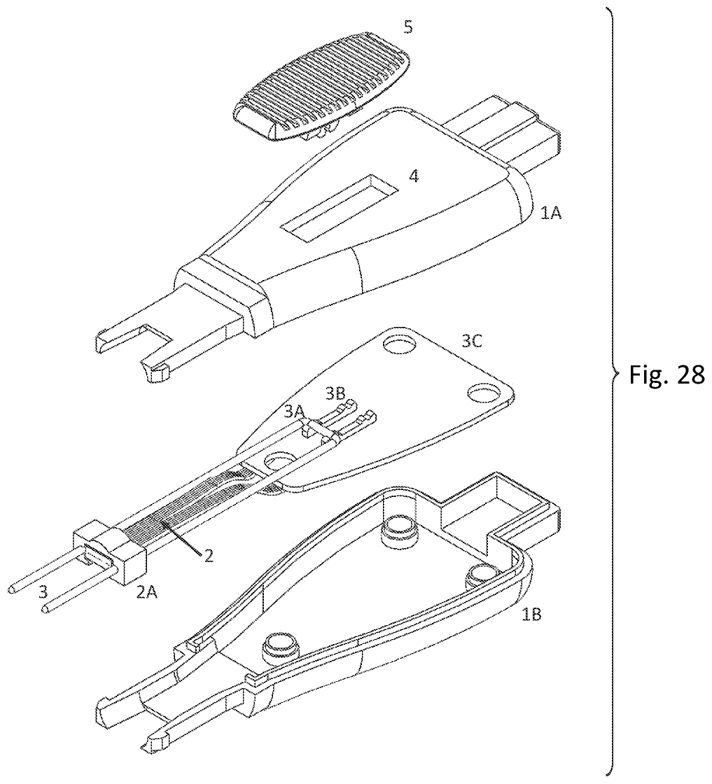

Referring now to FIGS. 1-28, Description 1: a housing and or module (1A mated with 1B) with the purpose of housing and protecting connectorized fiber cable and or cables 2 while being mated to a component 2A that is designed to secure and hold in place the ends of the said fiber and or fibers. Said component 2A is manufactured with a cavity and or cavities 2B for the purpose of having an alignment guide pin and or guide pins 3 be moved back and forth to create the function of a male pin 3A and or pins and or the function of a female cavity 3B.
Description 2: Said housing and or module 1A of Description 1 features a slot 4 on one side or top and or bottom of 1A for the purpose of retaining a slide switch 5 that allows movement back and forth of the alignment pins from the male position 3A and back to the female position 3B.
Description 3: Said slide switch 5 of Description 2 and Description 3 features a support leg 6 and or legs 6 that insert into the slot 4 of Description 2 with the purpose of retaining an alignment guide wire 3 and wires and or rods and or a pin and or pins 3 with the purpose of extending and retracting said alignment guide pins 3 and or equivalents to create a male alignment 3A when extended forward and a female cavity 3B when said switch is positioned into the retracted position.
Description 4: Said slide switch 5 of Description 2 and Description 3 is designed with additional length to allow and or act as an overhang 7 on each end that covers the open end of the switch leg slot 4 in the module housing 1A and 4 when the slide switch is positioned in either the male 3A or female 33 detent position and or in the process of being positioned into any or either position for the purpose of covering said slot 4 in the module housing to prevent dirt, moisture and foreign debris from entering said housing or module of Description 1 and Description 2.
Description 5: When the said slide switch (outlined in the Descriptions of 2, 3 and 4 above) in this invention is moved/transitioned from one position (being the forward/male detent position 3A) to another position (being the rear/female detent position 3B), the alignment guide wire 3 or guide wires 3 and or equivalents that are attached to the support leg 6 and or legs 6 (being part of said slide switch 5) will be motioned/moved by the pressure of the slide switch 5 movement through the alignment cavity and or cavities/openings 2A, to extend from the fiber end face and or end face locations and or retract back inside the module housing cavities 1A & 1B. creating an opening to receive the male pin and or pins of a fiber component being inserted.
Description 6: The module/housing of Description 1 features an interior wall/protective shelf 3C for the sole purpose a barrier for separating and preventing contact with the fiber cable and or cables 2 contained inside the module housing 1B (for the purpose of creating a loop back and or attenuation and or both) and the alignment guide wires 3 that are positioned in parallel and or adjacent to from abrasion of each other. The detent moldings 3A and or 3B are designed to act as a support arm creating a mechanism that creates a force when slide switch 5 is initially inserted in to the slot 4 in module 1 during initial assembly allowing guide pin wire to be pressed into the slot molded into the leg and or legs 6 molded into the switch 5.
Description 7: The Fiber connector coupler 1 when installed onto the loop back plug converts the male loop back plug of said invention described in the descriptions above from male fiber connector to a female fiber connector. When the alignment pin and or pins 3 described in this invention on the loop back plug by means of the slide switch 5 are set in the male position 3A and coupled with the coupler 1. The alignment pins 3 when extended and the coupler in place creates a female mating jack to accept and align cord plug-ins for the purpose of alignment of the multiple fiber end faces. The alignment pins when retracted and the coupler is in place creates a female jack for the purpose of looping back and or testing fiber and or the mating of like connectors for semi-permanent and or permanent installation. Said coupler when in place on the said loopback and or conventional plug connector provides an open cavity on one end to receive a (male) independent dust cover for the protection of the fiber end faces when the coupler is in place and not in use but being stored. Said coupler when in place on said invention can be used as a parking lot to contain and protect fiber end faces on loose cables when removed from fiber jacks for the purpose of testing the fiber jack connector. The said coupler when disconnected from said fiber loop back plug can also function for the purpose of mating fiber plug ends on cables to create additional length cables.
Description 8: The said slide switch 5 outlined and described in description 2, 3, 4, and 5 consists of a mating system that connects to the alignment pin 3 and or alignment pins 3 for the purpose of sliding said pins into the male 3A or female position 3B as outlined in Descriptions: 1, 2, 3, 4, 5, 6 and 7 above. Description 8 outlines the detent tabs 3A & 3B that are located in the protective shield module 3C to hold the said slide switch 5 and alignment pins 3 in an extended (male 3A) and or retracted (female 3B) detent position. The detent positions are located and designed into the protective module housing/shield 3C with the dual purpose of initially acting as a temporary support for the purpose of mating the alignment pin 3 and or pins 3 to the slide switch 5 and then acting as the detent component described in Description 7.
Description 9: The coupler of Description 7, when removed and a male dust cover is inserted into one end, the remaining open end can be fitted onto the plug-in end of the cord or cable that has been removed from its jack to allow for insertion of a loop back and or attenuator plug into the open jack. The coupler with dust cover inserted can now be used as a protective cover on the u-plugged cord protecting the fiber end faces.
Description 10: the invention described in the Descriptions above also can provide fiber attenuation components inside the module/housing outlined in the above Descriptions above 1 thru 10. The attenuated fiber loopback module used for testing and provisioning fiber optic data links. The attenuation level allows for directly connecting transmitter and receiver ports (looping back) without the need for a separate fiber cable and inline attenuators. The invention of this loop back with attenuation plug provides Male and or female testing outlined in the claims above.
Description 11. The openings 2B in the in the housing shown in 2A allow for the alignment and transition of the alignment pins 3 when being actuated by the lever control 5 for the purpose of switching from a male (forward) 3A position to a female (rear) 3B position with the function and or motion of a slide switch and or button 5.
Description 12. The descriptions outlined in the descriptions above are describing a mating module that consists of a module that incorporates a covering and support frame for a slide switch and or button. That slide switch and or button is then connected to an alignment wire and or wires with the purpose of moving said wire and or wires from one position (detent) to another position (detent). The said detent positions are molded into said shield cover 3C as described in the descriptions above that also serves as a protective platform 3C that shields and protects said fiber optic cables 2 and or components.
Description 13 is A MPO connector and or equivalents dust cover 9 can be stored in place when not in use by being positioned onto 8 which is molded said module housing 1A and 1B when combined and mated as a unit to receive said dust cover.
Description 14. The housing/module 1A and 1B feature an insert in the injection mold tooling so the rear of the module 8 can be changed out to feature an exit tunnel 9 and strain relief area 10 that will allow the fiber cable to connect to an MPO and or equivalents connector to be connectorized to said connector and or connectors 2 while the fiber trailing from the connector can run through the module/housing tunnel 9 and be secured by an internal strain relief 10 and the exit from the module housing to be connected to other equipment and or components.
Description 15. Said invention outlined in the descriptions regarding the male and or female function of the alignment pins and the mechanisms outlined in the descriptions above can be converted from a loop back plug described into a straight thru fiber plug as is common to the industry. The difference between the common to the industry plug would be the addition of the mechanics outlined in the descriptions above less the fiber being looped, but in this application the fiber would be directed out of the said module/housing end 9 and said fiber would be mated to another like component and or hardware and or test equipment.
Description 16: said invention outlines a slide switch 5 with the means of connection and function being supported by legs or a leg that provide a function of holding said switch in place while allowing a slide movement. Said leg and or legs provide a locking action holding said slide switch in place while allowing said movement of sliding switch to perform the said functions outlined in the descriptions above.

The foregoing Description of Embodiments is not intended to be exhaustive or to limit the embodiments to the precise form described. Instead, example embodiments in this Description of Embodiments are presented to enable persons of skill in the art to make and use embodiments of the described subject matter. Moreover, various embodiments have been described in various combinations. However, any two or more embodiments could be combined. Although some embodiments have been described in a language specific to structural features and/or methodological acts, it is to be understood that the subject matter defined in the appended Claims is not necessarily limited to the specific features or acts described above. Rather, the specific features and acts described above are disclosed by way of illustration and as example forms of implementing the Claims and their equivalents.

We claim:

1. A connector comprising:
a housing and with the purpose of housing and protecting connectorized fiber cable and or cables while being mated to a component;
said connector configured to secure and hold in place the ends of said connectorized fiber; and
a cavity having an alignment guide pin therein, said guide pin configured to be moved back and forth to create the function of a male pin when in a first position and to create the function of a female cavity when in a second position.
